(19) United States
(12) Patent Application Publication
(10) Pub. No.: US 2005/0212788 A1
(43) Pub. Date: Sep. 29, 2005

(54) Display driver and electronic instrument

(75) Inventors: Masafumi Fukuda, Matsumoto-shi (JP); Tadashi Yasue, Suwa-shi (JP)

Correspondence Address: OLIFF & BERRIDGE, PLC, P.O. BOX 19928, ALEXANDRIA, VA, 22320, US

(73) Assignee: SEIKO EPSON CORPORATION, Tokyo (JP)

(21) Appl. No.: 11/085,157

(22) Filed: Mar. 22, 2005

(30) Foreign Application Priority Data
Mar. 23, 2004 (JP) 2004-85384

(51) Int. Cl. G09G 3/36

(52) U.S. Cl. 345/204

(57) ABSTRACT

A display driver including: a decoder which decodes n-bit display data (n is an integer greater than one) sequentially input from a display memory in units of n bits; a plurality of latch circuits which latch output data from the decoder, and a pluality of data line driver sections which drive data lines of a display panel based on the data latched by the latch circuits. The n-bit display data is read from the display memory and output to the decor by performing wordline control once for the display memory. The decoder squentially outputs the decoded n-bit display data to the latch circuits. The data line driver sections drive the data lines after the decoded data has been stored in the latch circuits.

Japanese Patent Application No. 200485384, filed on Mar. 23, 2004, is hereby incorporated by reference in its entirety.

### BACKGROUND OF THE INVENTION

The present invention relates to a display driver and an electronic instrument.

In recent years, a display panel has been increasingly demanded accompanying an increase in functionality of electronic instruments. As a drive method for a display panel, various methods have been proposed. A driver circuit disclosed in Japanese Patent Application Laid-open No. 7-281636 has been known as an example. Japanese Patent Application Laid-open No. 7-281636 discloses a circuit which drives a display panel by using 10 column drivers when the display panel includes 640×480 pixels, for example. A calculation circuit is provided in each column driver. Since the calculation circuit simultaneously processes display data for 7 lines×480 columns read from a memory, the calculation circuit becomes complicated and the circuit area is increased.

Moreover, since the amount of display data is increased as the resolution of the display panel is increased, the driver circuit of the display panel also becomes complicated. If the circuit becomes complicated, manufacturing cost is increased due to an increase in the chip area and the design period. In particular, the area of the calculation circuit is considerably increased in the driver circuit disclosed in Japanese Patent Application Laid-open No. 7-281636.

### BRIEF SUMMARY OF INVENTION

According to a first aspect of the present invention, there is provided a display driver, comprising:

a decoder which decodes n-bit display data (n is an integer greater than one) sequentially input from a display memory in units of n bits;

a plurality of latch circuits which latch data decoded by the decoder; ad

a plurality of data line driver sections which drive data lines of a display panel based on the data latched by the latch circuits,

wherein the n-bit display data is read from the display memory and output to the decoder by performing wordline control once for the display memory,

wherein the decoder decodes the n-bit display data from the display memory and sequentially outputs the decoded data to the latch circuits; and

wherein each of the data line driver sections drives corresponding one of the data lines after the decoded data has been stored in the latch circuits.

According to a second aspect of the present invention, there is provided an electronic instrument, comprising:

the abovedescribed display driver;

a display panel;

a scan driver which drives scan lines of the display panel;

a controller which controls the display driver and the sa driver, and

a power supply circuit l

### BRIEF DESCRIPTION OF THE SEVERAL VIEWS OF THE DRAWING

FIG. 1 is a block diagram showing a display driver according to one embodiment of the present invention.

FIG. 2 shows a connection between an address decoder and latch circuits according to one embodiment of the present invention

FIG. 3 shows part of a shift register according to one embodiment of the present invention.

FIG. 4 shows the relationship between pixels of a display panel and display data stored in a display memory according to one embodiment of the present invention.

FIG. 5 is a block diagram illustrative of operations of an FRC decoder and an ML's decoder.

FIG. 6 shows the relationship among a display period, a frame period, and a field period according to one embodiment of the present invention.

FIG. 7 shows an example of a display pattern table according to one embodiment of the present invention.

FIG. 8 is illustrative of an operation of an FRC decoder according to one embodiment of the present invention.

FIG. 9 is a timing chart when a latch pulse is input to a latch circuit according to one embodiment of the present invention

FIG. 10 is a timing chart showing details of part of the period shown in FIG. 9.

FIG. 11 shows a display memory according to one embodiment of the present invention

FIG. 12 shows the relationship between display data and memory cells provided in a display memory according to one embodiment of the pr invention.

FIG. 13 shows a display driver in a comparative example.

FIG. 14 shows a display memory in the comparative example.

FIG. 15 is a circuit diagram showing part of the display memory in the comparative example.

FIG. 16 shows a display driver according to a modification of the embodiment of the present invention.

FIG. 17 is a block diagram showing part of a display driver having au address conversion circuit according to a modification of the embodiment of the present invention.

FIG. 18 shows an address decoder according to a modification of the embodiment of the present invention

FIG. 19 shows an address conversion circuit according to a modification of the embodiment of the present invention.

FIG. 20 is illustrative of a horizontal scroll display according to a modification of the embodiment of the present invention.

FIG. 21 is illustrative of a horizontal scroll display according to a modification of the embodiment of the present invention.

FIG. 22 is illustrative of a horizontal scroll display according to a modification of the embodiment of the present invention

FIG. 23 is illustrative of a horizontal scroll display according to a modification of the embodiment of the present invention.

FIG. 24 is illustrative of a right-left inversion display according to a modification of dc embodiment of the present invention.

FIG. 25 is illustrative of a right left inversion display according to a modification of the embodiment of the present invention.

FIG. 26 shows an address conversion circuit according to a modification of the embodiment of the present invention.

FIG. 27 shows an electronic instrument according to one embodiment of the present invention.

### DETAILED DESCRIPTION OF THE EMBODIMENTS

The present invention has been achieved in view of the above-described technical problem, and may provide a display driver and an electronic instrument having a small layout area and excelling in cost performance by reducing the circuit area of a driver circuit.

According to one embodiment of the present invention. there is provided a display driver, comprising:

a decoder which decodes n-bit display data (n is an integer greater than one) sequentially input from a display memory in units of n bits;

a plurality of latch circuits which latch data decoded by the decoder; and

a plurality of data line driver sections which drive data lines of a display panel based on the data latched by the latch circuits,

wherein the n-bit display data is read from the display memory and output to the decoder by performing wordline control once for the display memory;

wherein the decoder decodes the n-bit display data from the display memory and sequentially outputs the decoded data to the lath circuits; and

wherein each of the data line driver sections drives corresponding one of the data lines after the decoded data has been stored in the latch circuits.

In this embodiment, the n-bit display data is read by performing wordline control once, and the n-bit display data is decoded it becomes unnecessary to provide a decoder for each data line driver section by causing the decoder to decode the sequentially input n-bit display data and sequentially output the decoded data to the latch circuits, whereby the number of decoders can be reduced.

The display driver may further comprise:

an address decoder which generates a latch pulse used by the latch circuits to latch outputs from the decoder,

wherein the address decoder may select one of the lath circuits and output the latch pulse to the selected latch circuit based on address information on the display memory when the n-bit display data is read.

Since the latch circuit corresponding to the address information when reading the display data from the display memory can latch the output from the decoder, the data line indicated by the display data can be driven.

In this display driver, the n-bit display data may be read from the display memory in synchronization with one of a rising edge and a filling edge of a clock signal from a control circuit; and

the address decoder may output the latch pulse in synchronization with the other of the rising edge and the falling edge of the clock signal.

Since the latch pulse output timing from the address decoder and the display data read timing from the display memory can be caused to differ according to the clock signal, the address decoder can output the latch pulse to one of the latch circuits which is indicated by the data decoded by the decoder.

In this display driver, the latch circuits connected in series may form a shift register, an output terminal of one of the latch circuits being connected to an input terminal of one of the latch circuits in a subsequent stage; and

the shift register may shift data sequentially input from the decoder to one of the latch circuits in a first stage and store the shifted display data

Since the data decoded by the decoder can be sequentially stored in the latch circuits of the shift register by forming the shift register using the latch circuits, the decoded data can be stored in each latch circuit corresponding to one of the data line driver sections without complicated processing.

In this display driver, the decoder may include a multi-line select drive decoder; and

the multi-line select drive decoder may generate drive voltage select data based on display data for m pixels (m is an integer greater than one) extracted from the n-bit display data, and output the drive voltage select data to the latch circuits, the drive voltage select data being used for selecting one of drive voltages for multi-line select drive of scan lines.

This enables the number of multi-line select drive decoders to be reduced in comparison with tile latch circuits, whereby a display driver having a small circuit area can be provided

In this display driver, each of the data line driver sections may select a data line drive voltage from among the drive voltages, based on the drive voltage select data stored in the latch circuits; and

the data line driver sections may use the data line drive voltage to drive the data lines.

This enables the multi-line select drive to be performed for the display panel by storing the drive voltage select data in the latch circuits.

In this display driver, the decoder may include a grayscale decoder, and

the grayscale decoder may determine a display pattern of pixels indicated by the n-bit display data, based on the n-bit display data and frame information

This enables a grayscale representation based on the n-bit display data to be performed.

In this display driver, the grayscale decoder may output data “0” or “1” to at least one of the latch circuits based on the display pattern.

In this display driver, the decoder may either include a multi-line select drive decoder used for a multi-line select drive method in which m scan lines (m is an integer greater than one) are simultaneously selected and driven; and

the multi-line select drive decoder may output drive voltage select data to the latch circuits based on the display pattern, the drive voltage select data being used for selecting a data line drive voltage for driving the data lines.

This enables a grayscale representation and a multi-line select drive based on the n-bit display data to be performed for the display panel.

In his display driver, each of the data line driver sections may select the data line drive voltage from among a plurality of types of drive voltages used for multi-line select drive of the scan lines, based on the drive voltage select data stored in the latch circuits; and

each of the data line driver sections may use the data line drive voltage to drive the data lines.

In this display driver, a grayscale of each pixel in display data for m pixels 7 extracted from the n-bit display data may be indicated by k-bit grayscale data (k is an integer greater than one);

the grayscale decoder may include a grayscale ROM for determining a grayscale pattern which indicates two types of display states, based on the k-bit grayscale data and the frame information;

the grayscale decoder may determine the grayscale pattern for each of the m pixels based on the grayscale ROM, and output m-bit display data to the multi-line select drive decoder, the m-bit display data indicating a display state of each of the m pixels by using C “0” or “1” based on the determined grayscale pattern; and

the multi-line select drive decoder may generate the drive voltage select data based on the m-bit display data and output the drive voltage select data to the latch circuits.

According to one embodiment of the present invention, there is provided an electronic instrument, comprising:

the abovedescribed display driver,

a display panel;

a scan driver which drives Scan lines of the display panel;

a controller which controls the display driver and the scan driver, and

a power supply circuit

The embodiments of the present invention will be described below with reference to the drawings. Note that the embodiments described below do not in any way limit the scope of the invention laid out in the claims herein. In addition, not all of the elements of the embodiments described below should be taken as essential requirements of the present invention

1. Display Driver

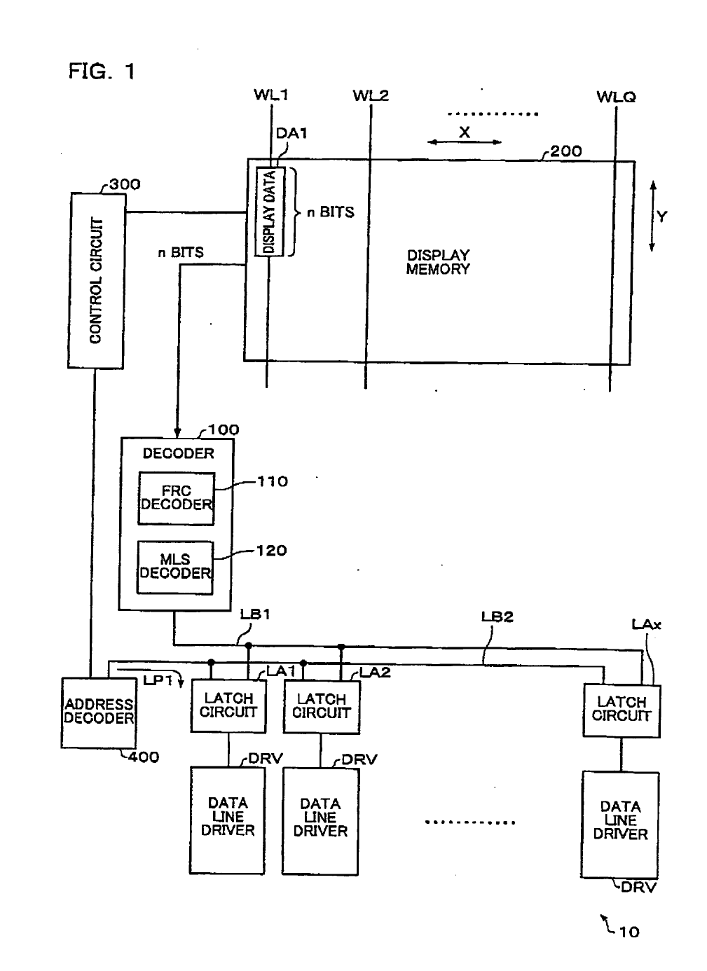

FIG. 1 is a block diagram of a display driver 10. In the present embodiment, the display driver 10 includes a decoder 100, a display memory 200, a control circuit 300, an address decoder 400, a plurality of data line driver sections DRV, and a plurality of latch circuits LA1 to LAx (x is an integer greater than one).

The decoder 100 includes an FRC decoder (grayscale decoder in a broad sense) 110, and an MLS decoder (multi-line select drive decoder in a broad sense) 120. The FRC decoder 110 uses a frame rate control (FRC) method as a grayscale display method. The FRC decoder 110 in the present embodiment can perform a four-grayscale representation by using 2-bit grayscale data (k-bit grayscale dam in a broad sense) for each pixel. However, the present invention is not limited thereto. For example, a 16-grayscale representation may be performed by setting the data length of the grayscale data to four bits. It suffices to set the data length of the grayscale data for the FRC decoder 110 corresponding to the number of grayscales necessary for a desired grayscale representation. The MLS decoder 120 use a multi-line select (MLS) drive method as a drive method. The MLS decoder 120 in the present embodiment performs a four-line select drive of scan lines of a display panel, for example. However, the present invention is not limited thereto. For example, the number of simultaneously selected lines may be arbitrarily set, such as a three-line select drive or a five- to eight-line select drive. The present embodiment can also deal with a color display, and one pixel in the present embodiment may be set to one of an R pixel, a G pixel, and a B pixel in RGB color display.

Display data for displaying an image on a display panel is stored in the display memory 200. Display data DA1 is made up of n-bit data (n-bit display data in a similar sense), and is read when a wordline WL1 of the display memory 200 is selected, for example. Specifically, at least one piece of display data DA1 can be read from the display memory 200 when one wordline is selected. In the present embodiment, the wordline is formed in the display memory 200 along a direction Y. A plurality of wordlines WL1 to WLQ (Q is an integer greater than one) are arranged in the display memory 200 along the direction X. However, the present invention is not limited thereto. For example, the number of wordlines may be one.

The display data DA1 includes grayscale data for a plurality of pixels (m pixels in a broad sense; m is an integer greater than one), for example.

The display memory 200 receives a control signal from the control circuit 300, selects the wordline WL1 based on the control signal, and outputs the n-bit display data DA1 to the decoder 100, for example. The control signal from the control circuit 300 includes a select signal (address information on the display memory in a broad sense) which selects one of the wordlines of the display memory 200.

The decoder 100 decodes the n-bit display data DA1 read from the display memory 200.

The FRC decoder 110 decodes the grayscale data for m pixels included in the n-bit display data DA1.

The MLS decoder 120 generates drive voltage select data based on the processing result from the FRC decoder 110, and outputs the drive voltage select data to the latch circuits LA1 to LAx. In the case where the number of simultaneously selected lines is set to four in the MLS drive method, since the number of types of voltages used in the data line driver section DRV is five, it suffices that the drive voltage select data be 3-bit data

The address decoder 400 receives the select signal (address information on the display memory) which selects the wordline, for example. The address decoder 400 selects one of the latch circuits LA1 to LAx. based on the select signal, and outputs a latch pulse to the selected latch circuit. The latch circuit which has received the latch pulse latches the drive voltage select data The latch pulse may be output without using the select signal (address information).

The display data DA1 is input to the decoder 100 when the wordline WL1 of the display memory 200 is selected, for example. The display data DA1 is decoded by the decoder 100, and the decoded data is output to a bus LB1 as the drive voltage select data The select signal which selects the wordline WL1 is output to the address decoder 400. The address decoder 400 outputs a latch pulse LP1 to the latch circuit LA1 through a bus LB2 based on the signal which selects the wordline WL1. Specifically, the latch circuit LA1 latches the drive voltage select data obtained by decoding the display data DA1. This data latch operation is performed by sequentially selecting the wordlines WL1 to WLQ.

The data line driver sections DRV drive data lines of the display panel based on the drive voltage select data stored in the latch circuits LA1 to LAx In other drawings, sections indicated by the same symbols have the same meanings.

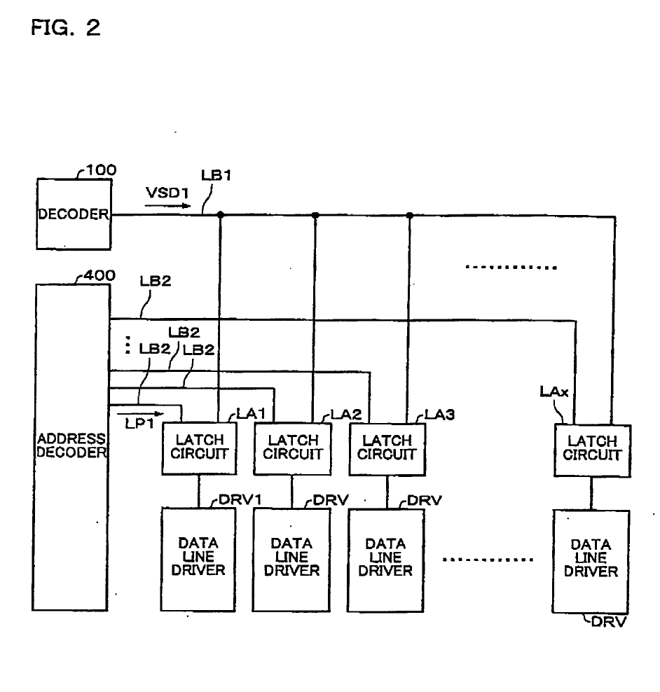

FIG. 2 is a diagram showing connection between the address decoder 400 and the latch circuits LA1 to LAx. In the case where a data line driver section DRVI drives the data line corresponding to the display data DA1, the drive voltage select data generated by decoding the display data DA1 is stored in the latch circuit LA1. The decoder 100 generates drive voltage select data VSD1 by decoding the display data DA1, and outputs the drive voltage select data VSD1 to the latch circuits LA1 to LAx through the bus LB1, as shown in FIG. 2. Since the address decoder 400 receives the control signal from the control circuit 300 and outputs the latch pulse LP1 only to the latch circuit LA1 corresponding to the display data DA1, the drive voltage select data VSD1 is latched by the latch circuit LA1. Since the select signal which selects the wordline of the display memory 200 is included in the control signal from the control circuit 300, the address decoder 400 can output the latch pulse to the latch circuit LA1 corresponding to the display data DA1 upon receiving the control signal from the control circuit 300.

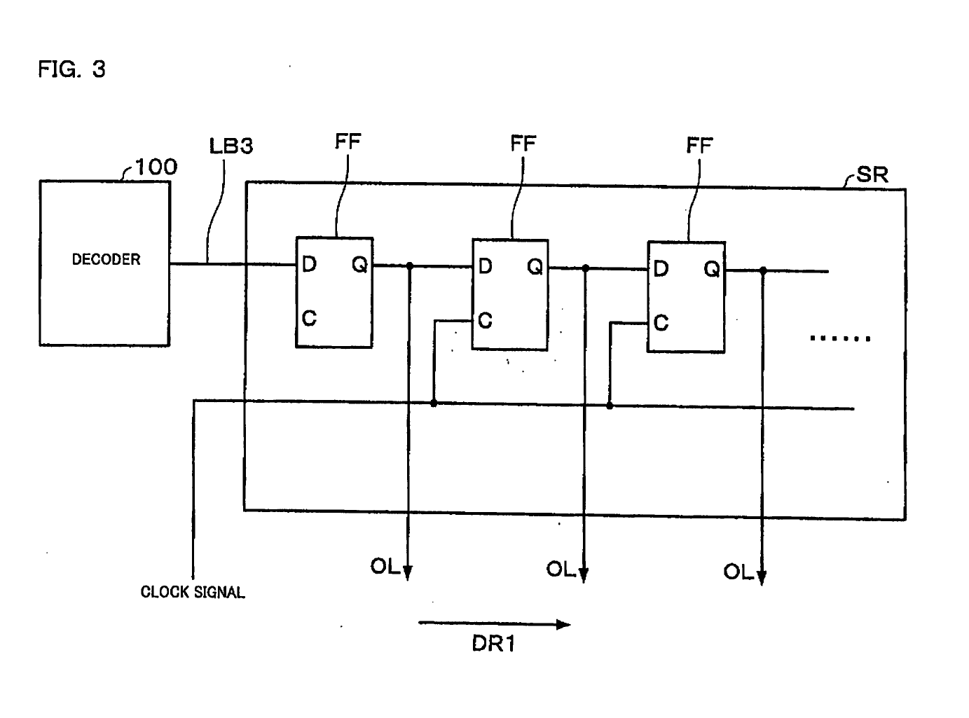

A shift register may be used instead of the address decoder 400 and the latch circuits LA1 to LAx FIG. 3 is a diagram showing a part of a configuration of a shift register SR. The shift register SR is formed by connecting a plurality of flip-flops FF (latch circuits in a broad sense) in series. A data output Q (output terminal in a broad sense) of the flip-flop FF in the preceding stage is connected with a data input D (input terminal in a broad sense) of the flip-flop FF in the subsequent stage. The drive voltage select data is input to the shift register SR from the decoder 100 through a bus LB3. The data stored in each flip-flop FF is shifted to the right in a direction DR1 in synchronization with a clock signal input to a clock input C of each flip-flop FF. An output line OL provided between each flip-flop FF is connected with the data line driver section DRV through a line latch circuit or the like. The drive voltage select data is stored in the line latch circuit or the like by outputting the latch pulse to the line latch circuit or the like after the data for one scan line has been stored in the shift register SR This enables the data line driver section DRV to drive the data line based on the drive voltage select data stored in the line latch circuit or the like.

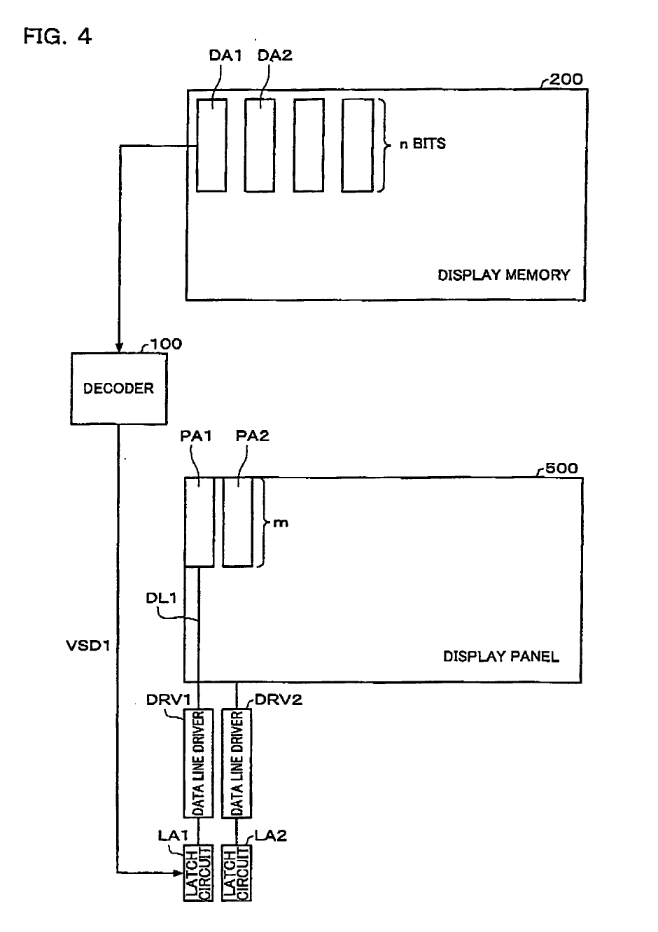

FIG. 4 is a diagram showing the relationship between the display data stored in the display memory 200 and pixels of a display panel 500. The display data DA1 from the display memory 200 is decoded by the decoder l00. The decoded data is stored in the latch circuit LA1 as the drive voltage select data VSD1. The data line driver section DRV1 drives a data line DL1 based on the drive voltage select data VSD1. In this case, simultaneously selected m pixels PA1 are voltage-controlled through the data line DL1. Specifically, the display data DA1 in the display memory 200 corresponds to the m pixels PA1 of the display panel 500 Likewise, display data DA2 in the display memory 200 corresponds to m pixels PA2 of the display panel 500.

In the case of using k-bit (k is an integer greater than one) grayscale data for one pixel, the n-bit display data DA1 obtained by selecting the wordline WL1 is made up of (k×m) bits in order to display the m pixels PA1. Specifically, (k×m)-bit display data is output to the decoder 100 by selecting one wordline of the display memory 200, and decode processing for displaying the m pixels on the display panel 500 is performed by the decoder 100.

2. Decoder

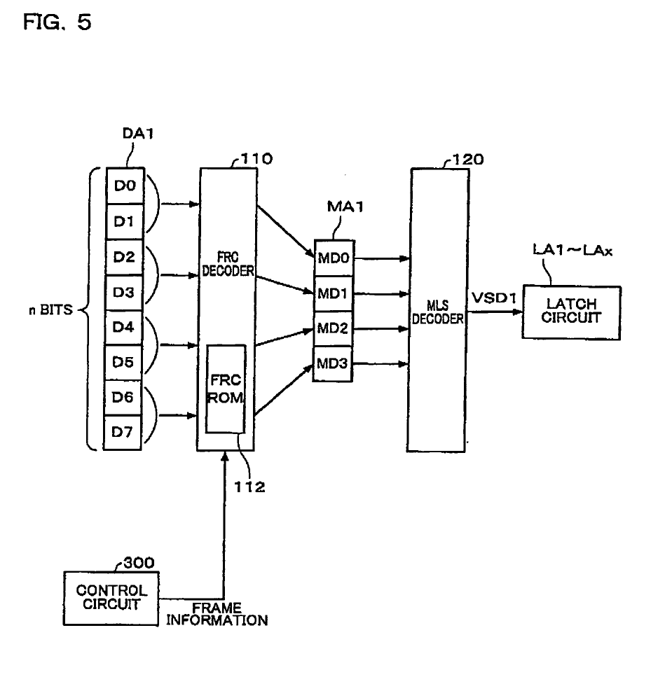

FIG. 5 is a block diagram illustrative of the operations of the FRC decoder 110 and the MLS decoder 120. FIG. 5 shows the case where the n-bit display data is the 8-bit display data DA1, for example. Symbols D0 to D7 indicate data of each bit of the 8-bit display data DA1. Since the decoder 100 in the present embodiment uses a four-grayscale representation and a four-line select drive method (multi-line select drive method which simultaneously selects and drives m scan lines in a broad sense), the 8-bit display data DA1 includes display data for four pixels, and the grayscale of each of the four pixels is indicated by 2-bit grayscale data. The four pixels indicated by the 8-bit display data DA1 are called first to fourth pixels. Specifically, the data D0 and D1 of the display data DA1 is the grayscale data for the first pixel, and the data D2 and D5 is the grayscale data for the second pixel. Likewise, the data D4 to D7 of the display data DA1 is the grayscale data for the third and fourth pixels.

The 8-bit display data DA1 is decoded by the FRC decoder 110. The FRC decoder 110 includes an FRCROM 112 (grayscale ROM in a broad sense). However, the present invention is not limited thereto. The FRC decoder 110 receives frame information from the control circuit 300. A frame number when the display data DA1 is decoded is included in the frame information. The FRCROM 112 is a storage circuit which stores a display pattern table for determining i-bit data (display pattern in a broad sense) for each pixel based on the frame number and the pixel grayscale data.

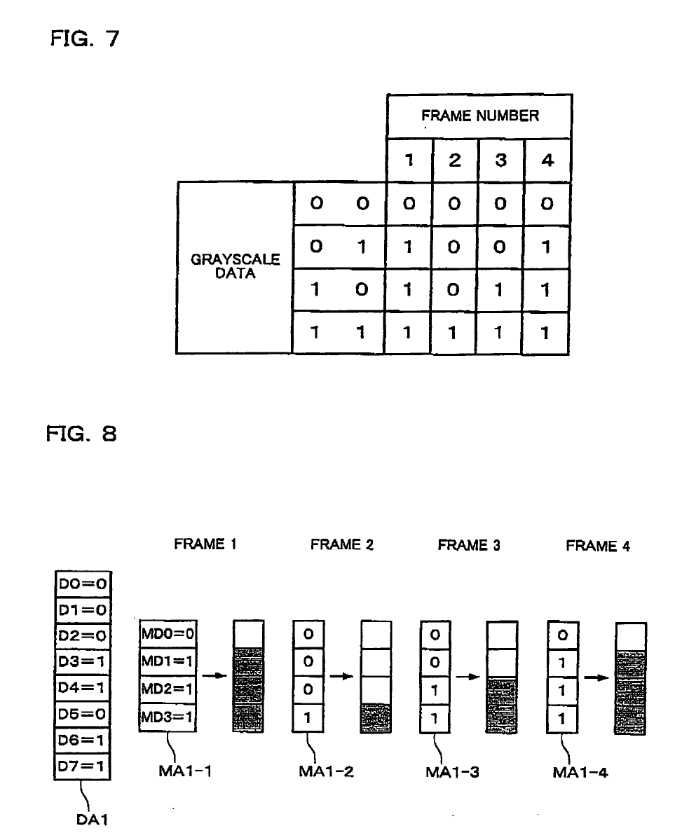

The FRC decoder 110 outputs 4-bit (m-bit in a broad sense) display data MAI (display data for m pixels in a broad sense) from the frame information and the grayscale data D0 to D7 for the first to fourth pixels based on the display pattern table (see FIG. 7) stored in the FRCROM 112. In FIG. 5, symbols MD0 to MD3 indicate data of each bit of the display data MA1.

The MLS decoder 120 generates the drive voltage select data VSD1 by decoding the 4-bit display data MA1, and outputs the drive voltage select data VSD1 to the latch circuits LA1 to LAx. The drive voltage select data VSD1 is latched by the latch circuit LA1 among the latch circuits LA1 to LAx which has received the latch pulse LP1 from the address decoder 400, for example.

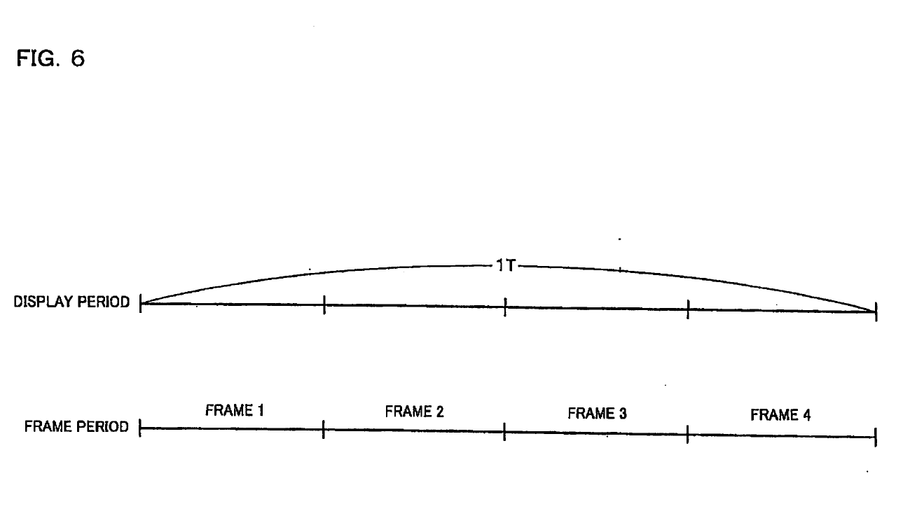

In the FRC grayscale method (frame grayscale method), when a display period in which one frame is displayed is a display period 1T, the display period 1T is divided into a plurality of frame periods, and whether or not to display a pixel is controlled in each frame period The FRC grayscale method realizes a grayscale representation by adjusting the number of frame periods in which a pixel is displayed. The frame number included in the above-mentioned frame information is a number for alternatively indicating each frame period. FIG. 6 shows an example in which the display period 1T is divided into four fame periods. In the case of performing a four-grayscale representation, when the 2-bit grayscale data is (I1), a pixel is displayed in all of frame periods 1 to 4 shown in FIG. 6, for example. When the 2-bit grayscale data is (01), a pixel is displayed in one of the frame periods 1 to 4 shown in FIG. 6, for example. The number of frame periods when performing the four-grayscale representation is not limited to four. The number of frame periods may be set to an arbitrary number of three or more corresponding to the number of patterns necessary for normally displaying the grayscale.

FIG. 7 shows an example of the display pattern table. The FRC decoder 110 outputs the display data MA1 according to the display pattern table stored in the FRCROM 112. The display pattern table is a table for determining a 1-bit value based on tie frame number and the grayscale data as shown in FIG. 7, for example. When decoding the display data in the frame period 1 shown in FIG. 6, specifically, when the frame number is “1”, a value “0” is output for the pixel grayscale data (00). When the frame number is “4”, a value “0” is output for the pixel grayscale data (00), and a value “1” is output for the pixel grayscale data (10).

Display data MA1-1 to MA14 shown in FIG. 8 indicates the display data MA1 which is decoded and output in each frame period when the values of the data D0 to D7 of the display data DA1 are (00011011), for example. In the frame period 1, the values of the data MD0 to MD3 of the display data MA11: are decoded and output as (0111) according to the display pate table shown in FIG. 7. In the frame period 2, the values of the data MD0 to M3 of the display data MA1-2 are output as (0001). Likewise, the values of the data MD0 to MD3 of the display data MA1-3 and MA14 are output as (0011) and (0111), respectively.

FIG. 8 shows that a pixel is displayed when the value of each piece of data of the display data is “1”, and a pixel is displayed when the value of each piece of data is “0”. However, “1” and “0” may be reversed

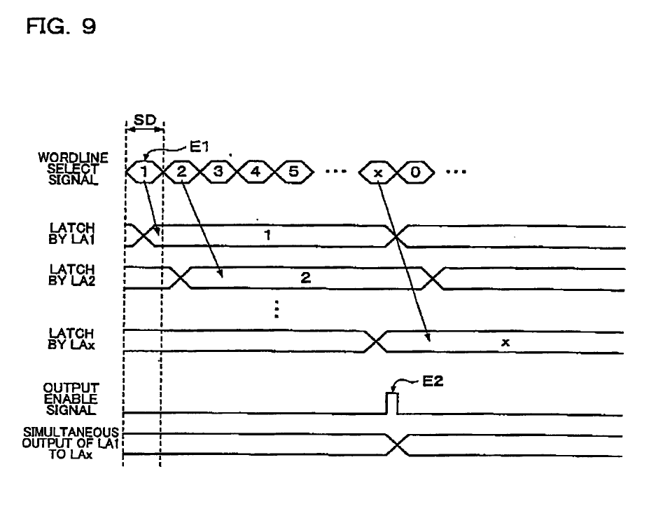

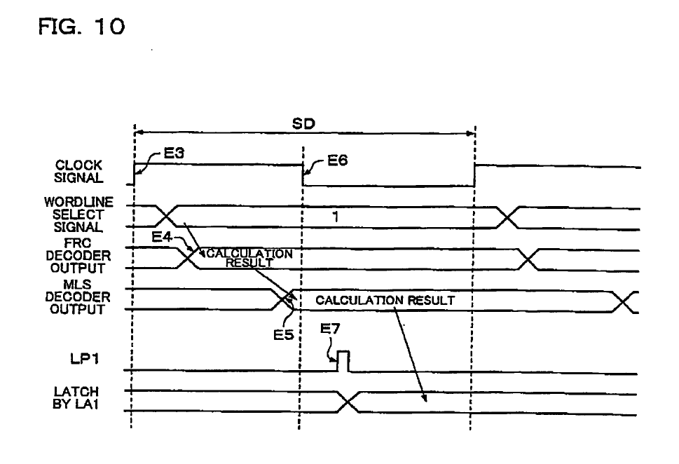

A flow in which the n-bit display data from the display memory 200 is sequentially decoded and the drive voltage select data is output to the latch circuits LA1 to LAx is described below using FIGS. 9 and 10.

FIG. 9 is a timing chart when the latch pulse is input to the latch circuits LA1 to LAx. A wordline select signal is the select signal (address information on the display memory in a broad sense) for selecting one of the wordlines of the display memory 200. The drive voltage select data is latched by the latch circuit LA1 based on the wordline select signal indicated by a symbol E1. The wordlines WL1 to WLQ of the display memory 200 are sequentially selected, whereby the drive voltage select data is latched by the latch circuits LA1 to LAx. After the drive voltage select data has been latched by the latch circuits LA1 to LAx, an output enable signal indicated by a symbol E2 is output to the data line driver sections DRV, and the data lines are driven by the data line driver sections DRV.

FIG. 10 is an enlarged timing chart of the period indicated by a symbol SD shown in FIG. 9. The period SD corresponds to one cycle of the clock signal, for example. The wordline select signal is output from the control circuit 300 to the display memory 200 in synchronization with the rising edge of the clock signal indicated by a symbol E3. In the display memory 200, the wordline WL1 is selected based on the wordline select signal, for example. The display data DA1 is input to the FRC decoder 110 at the timing indicated by a symbol E4 and is decoded by the FRC decoder 110, for example. The data decoded by the FRC decoder 110 is input to the MLS decoder 120 at the timing indicated by a symbol E5 and is decoded by the UES decoder 120, for example. The dam decoded by the MLS decoder 120 is output to the latch circuits LA1 to LAx as the drive voltage select data VSD1, for example.

The latch pulse LP1 indicated by a symbol E7 is output to the latch circuit LA1 from the address decoder 400 in synchronization with the failing edge of the clock signal indicated by a symbol E6, for example. This enables the latch circuit LA1 to latch the drive voltage select data VSD1 generated by the MLS decoder 120.

The MLS decoder 120 has decoded the data output for the FRC decoder 110 in a period before the filling edge of the clock signal indicated by the symbol E6. Therefore, the MLS decoder 120 can output the drive voltage select data VSD1 at the timing of the falling edge of the clock signal indicated by the symbol E6.

The wordline select signal is output in synchronization with the rising edge of the clock signal, and the latch pulse LP1 is output in synchronization with the fling edge of the clock signal, for example. However, the present invention is not limited thereto. The wordline select signal may be output in synchronization with the falling edge of the clock signal, and the latch pulse LP1 may be output in synchronization with the rising edge of the clock signal, for example.

A feature that the rising/falling edge of the clock signal is in synchronization with the rising/falling edge of another signal includes the case where the time difference between the rising/falling edge of the clock signal and the rising/falling edge of another signal is uniform, and also includes the case where the rising/falling edge of another signal is set at the same time as the falling edge of the clock signal.

3. Display Memory

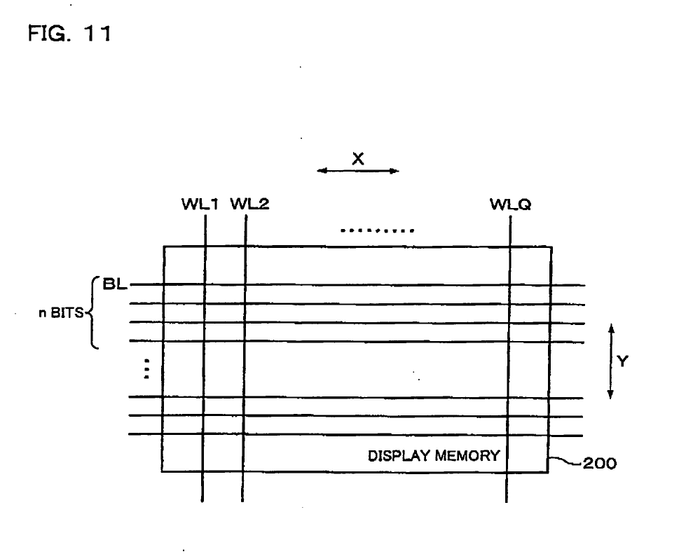

FIG. 11 shows the display memory 200. A plurality of bitlines BL are provided in the display memory 200. The bitline BL is formed along the direction X. When the wordline WL1 is selected, n-bit data is output through the bitlines BL, for example.

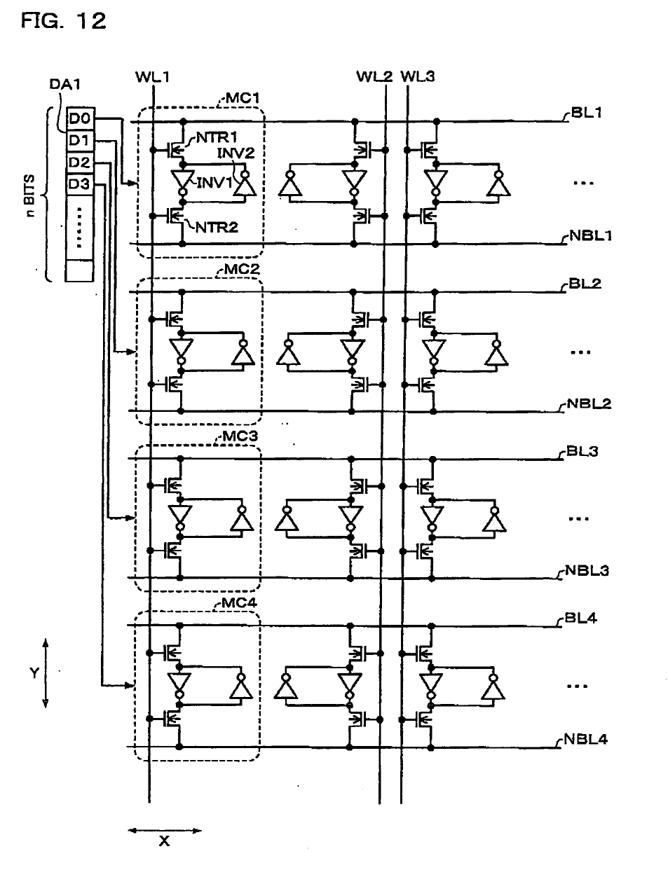

FIG. 12 shows the relationship between a plurality of memory cells provided in the display memory 200 and the display data DA1. FIG. 12 shows a part of the display memory 200. An inversion signal obtained by reversing a signal input to each of bitlines BL1 to BL4 is input to each of bitlines NBL1 to NBL4, respectively. Each memory cell of the display memory 200 includes N-type transistors NTR1 and NTJR2 and inverters INV1 and INV2. For example, data is read from and written into a memory cell MC1 through the bitlines BL1 and NBL1. Specifically, since data is input to and output from the memory cell MC1 through single system lines, the memory cell MC1 is called a one-port memory cell.

When the wordline WL1 is selected, the N-type transistors NTR1 and NTR2 of the memory cell MC1 are named ON. This enables data to be read from the memory cell MC1 or data to be written into the memory cell MC1. The display data DA1 is stored in the display memory 200 in which such one-port memory cells are arranged. The data D0 of the n-bit display data DA1 is stored in the memory cell MC1, for example. The data D1 of the n-bit display data DA1 is stored in the memory cell MC2, for example. The data D2 and D3 of the display data DA1 is respectively stored in the memory cells MC3 and MC4, for example.

The display data DA1 stored in the display memory 200 is output to the decoder 100 by selecting the wordline WL1. For example, the data D0 of the display data DA1 can be read by reading outputs from the bitlines BL1 and NBL1 using a sense amplifier or the like. The data D2 and D3 of the display data DA1 can be read by reading outputs from the bitlines BL2 to BL4 and the bitlines NBL2 to NBL4.

4. Comparative Example

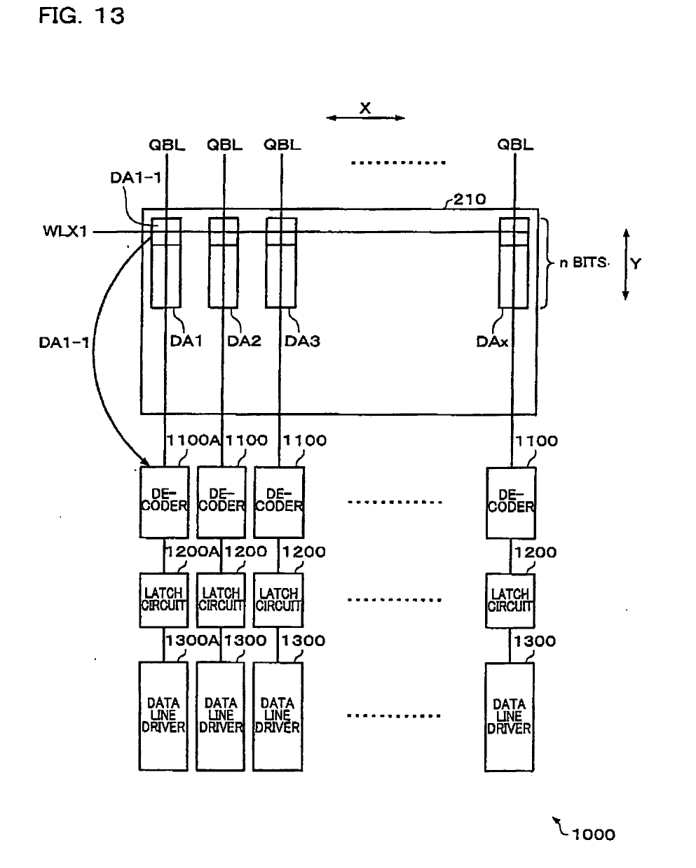

FIG. 13 is a diagram showing a display driver 1000 in a comparative example. The display memory 1000 includes a display memory 210, a plurality of decoders 1100, a plurality of latch circuits 1200, and a plurality of data line driver sections 1300, for example. The decoder 1100 includes a grayscale decoder which decodes grayscale data, and a multi-line select drive decoder which generates data which selects a drive voltage of the data line driver section 1300, for example.

A wordline is formed in the display memory 210 along the direction X. A plurality of bitlines QBL are formed in the display memory 210 along the direction Y, and are arranged along the direction x. A plurality of wordlines WLX are arranged in the display memory 210 along the direction Y. FIG. 13 shows one wordline WLX1 for convenience of description.

When the wordline WLX1 is selected, 1-bit data DA1-1 stored in a memory cell connected with the wordline WLX1 is output to a decoder 1100A from the n-bit display data DA1 stored in the display memory 210. 1-bit data stored in each memory cell connected with the wordline WLX1 is output from n-bit display data DA2 to DAx (x is an integer greater than one) to the corresponding decoder 1100 through each bitline QBL.

Specifically, 1-bit display data is output to each decoder 1100 by select one wordline. In the case where the amount of information necessary for the decoder 1100 to decode the display data is n bits, a latch circuit or the like may be provided to each decoder 1100, and n-bit data may be stored in the decoder 1100 by selecting the wordlines n times.

However, as the resolution of the display panel is increased, the number of decoders 1100 is increased accompanying an increase in the number of data lines An increase in the number of decoders 1100 increases the chip area, whereby manufacturing cost is increased. In the display driver 10 in the present embodiment, since one decoder 100 outputs the drive voltage select data to the latch circuits LA1 to LAx, the chip area can be significantly reduced. A reduction in the chip area reduces manufacturing cost and increases the degrees of freedom of the layout

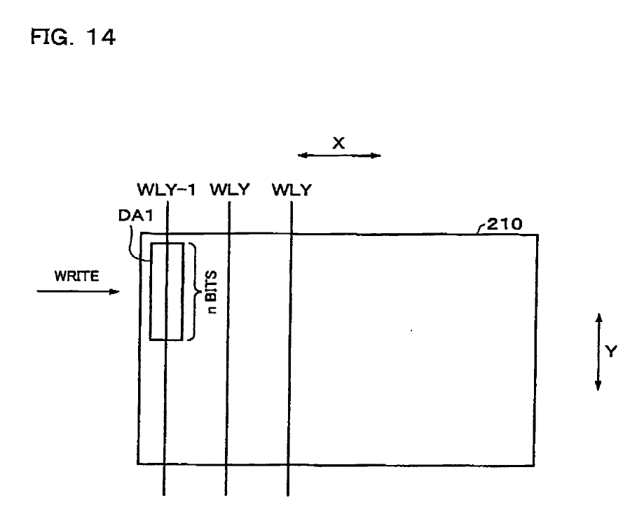

The operation of writing display data into the display memory 210 of the display driver 1000 in the comparative example is described below. FIG. 14 is a diagram showing the display memory 210 in the comparative example. The display memory 210 includes a plurality of wordlines WLY in addition to the bitlines QBL. The wordline WLY is formed in the display memory 210 along the direction Y. In the case of writing the n-bit display data DA1 into the display memory 210, the wordline WLY-1 is selected, whereby the display data DA1 is written into the memory cells connected with the wordline WLY-1. Specifically, data of each bit of the n-bit display data DA1 is stored in the memory cells arranged along the direction Y. The arrangement of the memory cells in which the data of each bit of the display data DA1 is stored is the same as that for the n-bit display data DA1 stored in the display memory 200 in the present embodiment.

Specifically, the display data DA1 can be written into the display memory 200 in the same manner as in the case of using the display driver 1000 in the comparative example. For example, a memory control program created for using the display driver 1000 in the comparative example may be easily applied to the display driver 1000 in the present embodiment The design period can be reduced by providing compatibility with the display driver 1000 in the comparative example as to the writing method of the display data into the display memory.

In the display memory 200 in the present embodiment, the amount of data which can be stored in unit area of the display memory is greater than that of the display memory 210 in the comparative example. Specifically, the layout size per bit of the memory cell is reduced, and the number of interconnects provided in the display memory is also reduced Therefore, the display driver 10 including the display memory 200 enables the chip area to be significantly reduced in comparison with the display driver 1000 in the comparative example, whereby manufacturing cost is reduced.

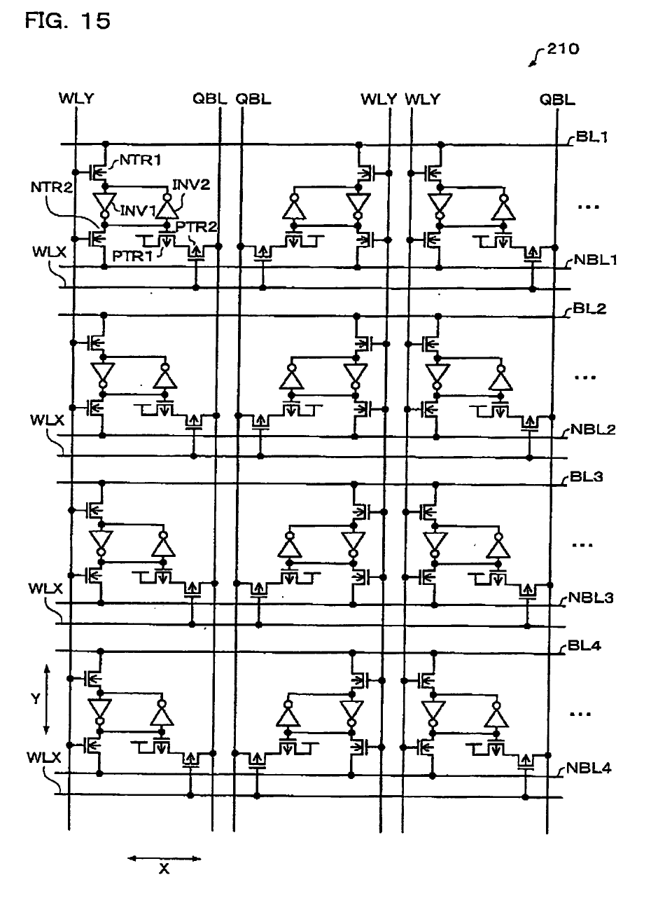

In order to describe the above-described effect, FIG. 15 provides a circuit diagram showing a part of the display memory 210 in the comparative example. The wordlines WLY, the bitlines QBL, and the wordlines WLX are provided in the display memory 210. The bitlines BL and NBL are formed in the display memory 210 along the direction X. FIG. 15 shows only the bitlines BL1 to BXA and NBL1 to NBL4. In the display memory 210, a memory cell which can store 1-bit data includes N-type transistors NTRL and NnR2 and P-type transistors PTR1 and PTR2. The memory cell of the display memory 210 includes inverters IN1 and IKV2.

When writing the display data into the display memory 210, the wordline WLY formed along the direction Y is selected, and the data is written into the memory cell through to bitlines BL and NBL formed along the direction X When reading the display data from the display memory 210, the wordline WLX formed along the direction X is selected, and the data stored in the memory cell is output through the bitline QBL formed along the direction Y In the case where the data is input to one memory cell through two systems consisting of the bitlines BL1 and NBL1, and the data stored in the memory cell is output through one system consisting of the bitline QBL which is another system of the bitlines BL1 and NBL1, such a memory cell is called a 1.5-port memory cell.

The P-type transistors PTR1 and PTR2 provided in the 1.5-port memory cell in the comparative example are not provided in the one-port memory cell shown in FIG. 12. The wordlines WLX and the bitlines QSL provided in the display memory 210 in the comparative trample are not provided in the display memory 200 in the present embodiment Specifically, in the case where the display memory 200 and the display memory 210 can store the same amount of data, the display memory 200 in the present embodiment enables the chip size to be significantly reduced in comparison with the display memory 210 in the comparative example

5. Modification

The display driver 10 shown in FIG. 1 includes the decoder 100, the display memory 200, the control circuit 300, the address decoder 400, the data line driver sections DRV, and the latch circuits LA1 to LAx. However, the present invention is not limited thereto. For example, some of the above-described circuits may be omitted from the display driver 10, or the display driver 10 may include another circuit, For example, the display memory 200, the control circuit 300, or the address decoder 400 may be omitted from the display driver 10.

The decoder 100 shown in FIG. 1 includes the FRC decoder 110 and the NLS decoder 120. However, the present invention is not limited thereto. For example, the FRC decoder 110 or the MLS decoder 120 may be omitted from the decoder 100.

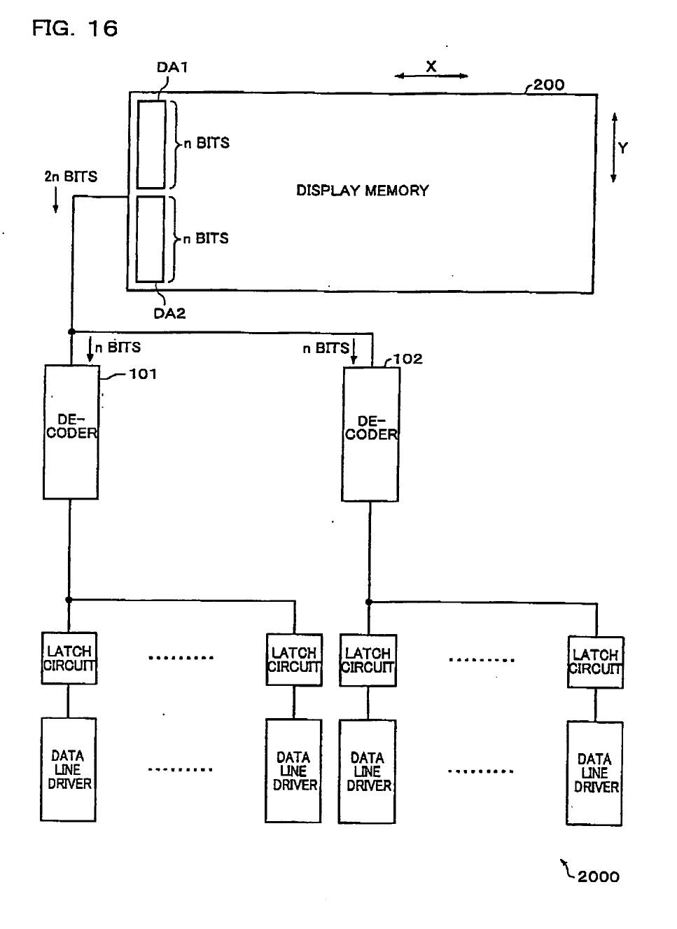

FIG. 16 shows a modification of the display driver 10 in the present embodiment. A display driver 2000 which is a modification of the present embodiment includes the display memory 200, decoders 101 and 102, a plurality of latch circuits, and a plurality of data line driver sections. However, the present invention is not limited thereto. For example, the display driver 2000 may have a configuration in which the display memory 200 is omitted. 2 n-bit data consisting of the n-bit display data DA1 and the n-bit display data DA2 is read from the display memory 200. The n-bit display data DA1 of the 2n-bit data is output to the decoder 101, and the n-bit display data DA2 is output to the decoder 102, for example. The decode processing of the display data cannot be completed within one display period as the resolution of the display panel is increased, whereby the display state of the display panel may be affected. However, since the decode processing of the display data can be distributed over the decoders 101 and 102 by using the display driver 2000, the display data can be displayed on the display panel at a high image quality even if the display panel has a higher resolution.

As another modification, the case of providing an address conversion circuit 410 in the address decoder 400 of the display driver 10 shown in FIG. 1 is described below. A horizontal scroll display or a right-left inversion display can be easily performed for the display panel without rewriting the display data written into the display memory 200 by providing the address conversion circuit 410.

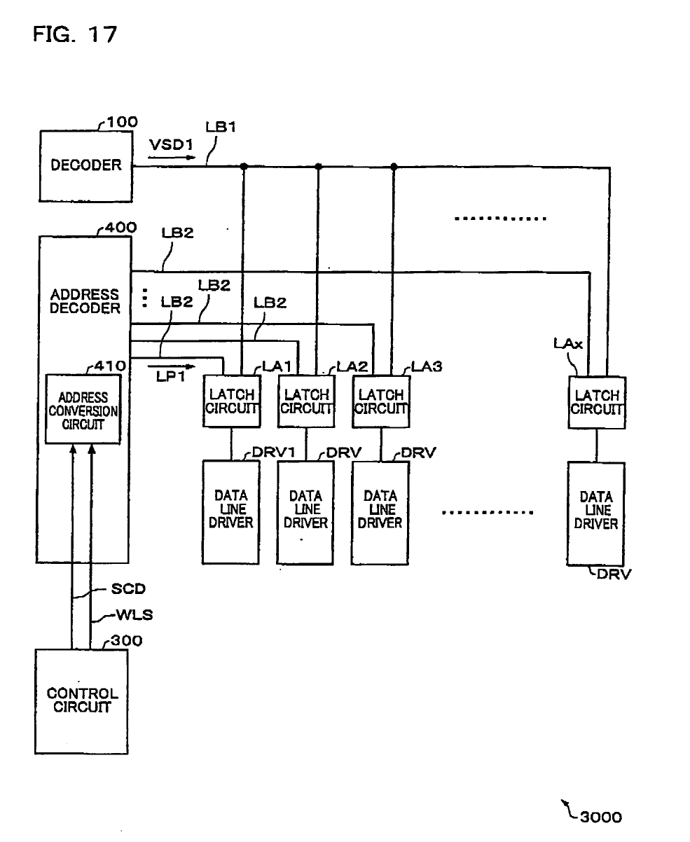

A horizontal scroll display is described below. FIG. 17 is a block diagram showing a part of a display driver 3000 in which the address conversion circuit 410 is provided. The address conversion circuit 410 performs calculation processing of horizontal scroll data SCD and a wordline select signal WLS including address information on the selected wordline of the display memory 200, and selects the latch circuit based on the calculation result. The display data can be horizontally scrolled on the display panel by setting the horizontal scroll data SCD.

The address decoder 400 receives the wordline select signal WLS from the control circuit 300, and outputs the latch pulse to the latch circuit selected by the address conversion circuit 410. The address conversion circuit 410 receives the horizontal scroll data SCD from the control circuit 300 separately from the wordline select signal. The wordline address information included in the wordline select signal includes information which can designate one of the addresses assigned to the latch circuits LA1 to LAx. This information enables the address decoder 400 to obtain one of the addresses assigned to the latch circuits LA1 to LAx from the wordline address information. When the value of the horizontal scroll data SCD is “0”, a normal display is performed instead of the horizontal scroll display. In more detail when the wordline WL1 is selected, the decoder 100 outputs the drive voltage select data VSDL to the bus LB1. When the value of the horizontal scroll data SCD is “0”, the address conversion circuit 410 selects the latch circuit LA1 based on the address assigned to the latch circuit LA1. The address decoder 400 outputs the latch pulse LP1 to the latch circuit LA1, whereby the drive voltage select data VSD1 is stored in the latch circuit LA1. The data line driver section DRV1 drives the data line, hereby the pixels corresponding to the display data DA1 are displayed.

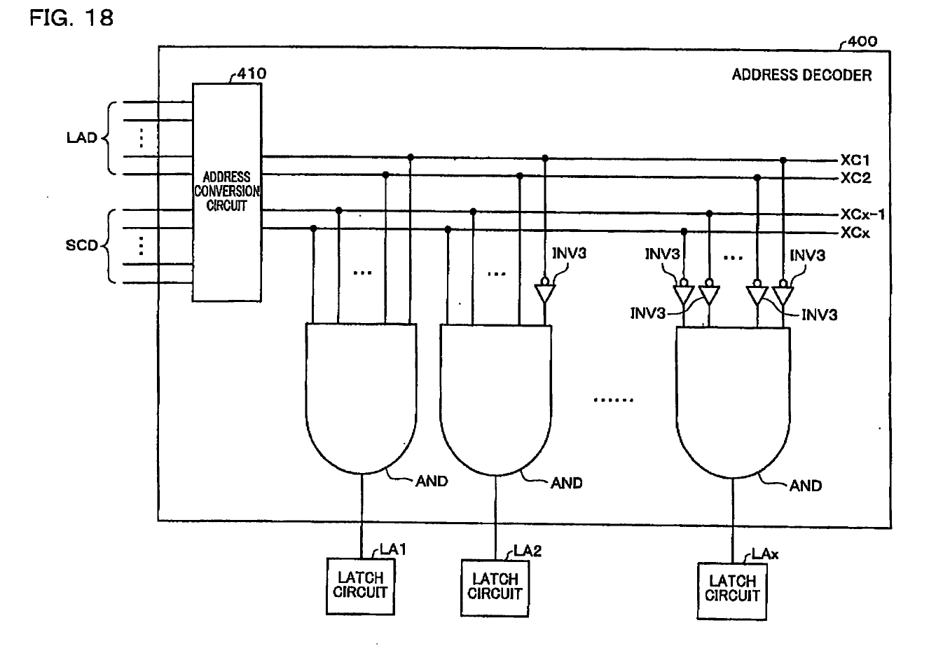

FIG. 18 is a block diagram showing the address decoder 400. Latch address data LAD indicates data of the address assigned to the latch circuit included in the wordline address information. The address conversion circuit 410 performs calculation processing of the latch address data LAD and the horizontal scroll data SCD. When each bit of the calculation result data is indicated by C1 to Cx, the address conversion circuit 410 outputs data XC1 to XCx obtained by reversing the data C1 to Cx to a plurality of logic circuits AND. Each logic circuit AND includes at least x inputs. Inverters INV3 are provided to each logic circuit AND in the exclusive combination so to each logic circuit AND which has received the data XC1 to XCx from the address conversion circuit 410 exclusively outputs a true value (value “1” or high-level signal, for example). The output of each logic circuit AND is connected with the latch circuits LA1 to LAx. Therefore, the latch circuits LA1 to LAx can exclusively receive the latch pulse.

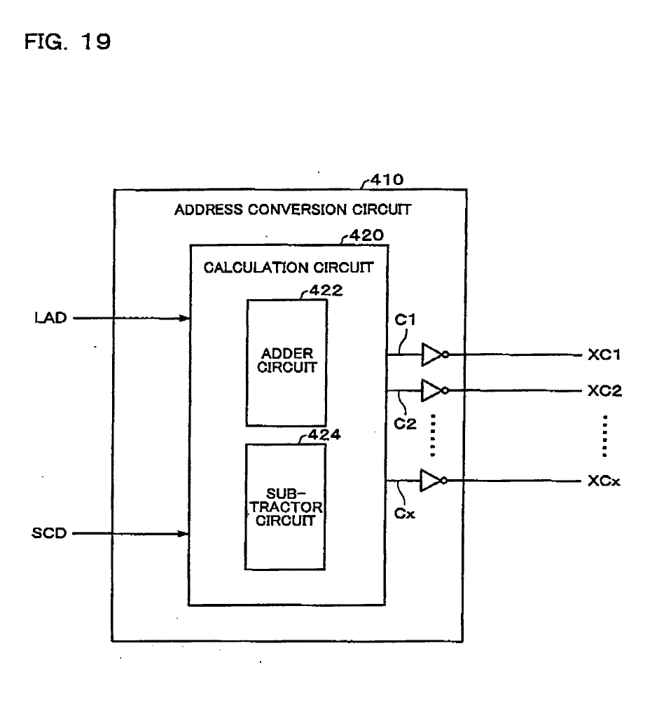

FIG. 19 is a diagram showing the address conversion circuit 410. The address conversion circuit 410 includes a calculation circuit 420. The calculation circuit 420 includes an adder circuit 422 and a subtractor circuit 424. However, the present invention is not limited thereto. The adder circuit 422 or the subtractor circuit 424 may be omitted The address conversion circuit 410 which has received the latch address data LAD and the horizontal scroll data SCD performs calculation processing using the calculation circuit 420. The calculation circuit 420 performs addition processing or subtraction processing of the latch address data LAD and the horizontal scroll data SCD. When performing addition processing, the adder circuit 422 adds the latch address data LAD to the horizontal scroll data SCD, for example. When performing subtraction processing, the subcontractor circuit 424 subtracts the horizontal scroll data SCD from the latch address data LAD, for example. The addition result or the subtraction result is output as the output data from the calculation circuit 420. The data C1 to Cx of each bit of the output data from the calculation circuit 420 is reversed by inverters or the like, and output as the data XC1 to XCx.

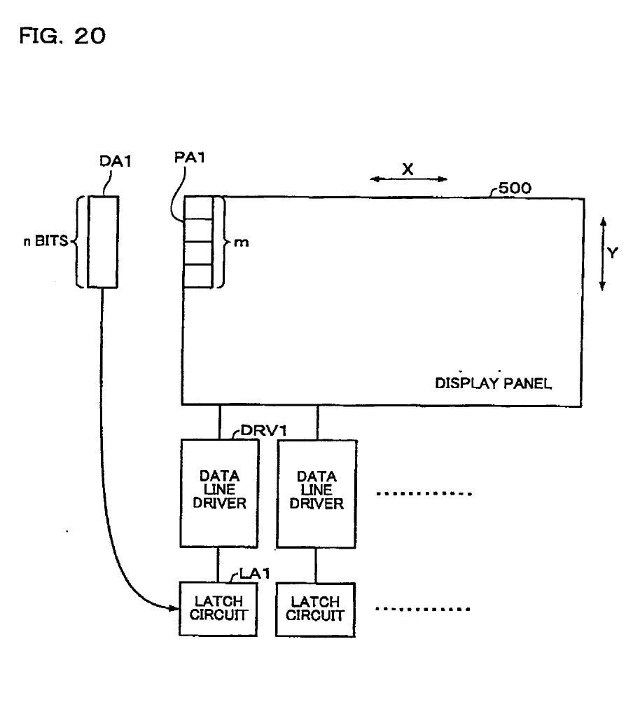

A flow of the horizontal scroll display is described below using FIGS. 20 to 23. FIG. 20 is a diagram showing the m pixels PA1 displayed using the n-bit display data DA1 when the value of the horizontal scroll data SCD is “0”, for example. The horizontal scroll data SCD is set to “0” when not performing the horizontal scroll display, for example. This allows the latch pulse to be output to the latch circuit LA4 according to the latch address data LAD, whereby the n-bit display data DA1 is decoded by the decoder 100 and is latched by the latch circuit LA1. Specifically, the data line is driven by the data line driver section DRV1. whereby the m pixels PA1 of the display panel 500 are displayed.

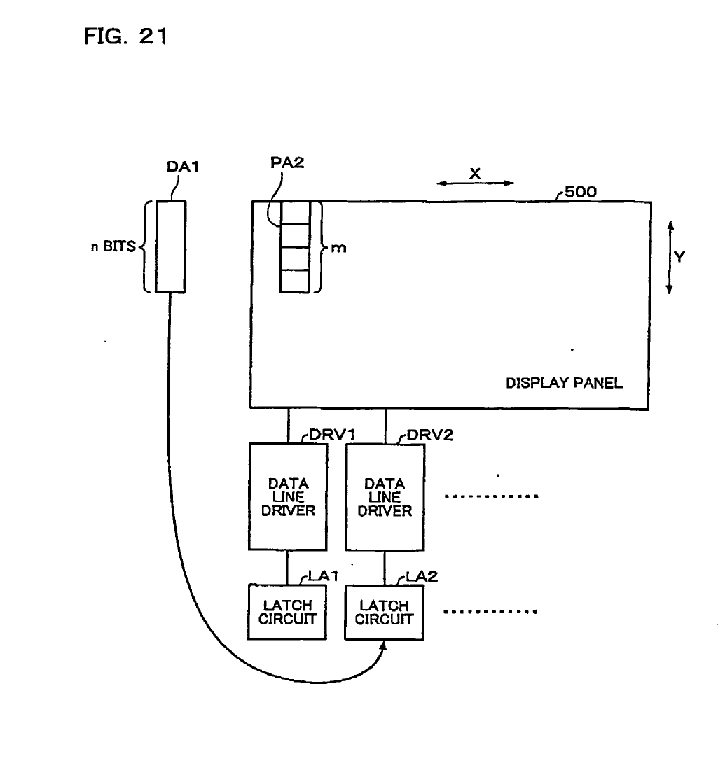

FIG. 21 is a diagram showing the case of performing the horizontal scroll display for one pixel to the right along the direction X In the case of performing the horizontal scroll display for one pixel to the right along the direction X, the horizontal scroll data SCD is set to “1”, for example. The calculation circuit 420 shown in FIG. 19 performs addition processing of the latch address data LAD and the horizontal scroll data SCD, for example. This causes the output from the address conversion circuit 410 to be data indicating the latch circuit LA1 differing from FIG. 20. The address decoder 400 outputs the latch pulse to the latch circuit LA1 according to the output from the address conversion circuit 410. This causes the n-bit display data DA1 to be decoded by the decoder 100 and latched by the latch circuit LA2. Specifically, the data line driver section DPV2 drives the data line, whereby the m pixels PA2 are displayed. Specifically, as is clear from the comparison between the m pixels PA1 shown in FIG. 20 and the m pixels PA2 shown in FIG. 21, the horizontal scroll display for one pixel to the right along the direction X can be performed by setting the value of the horizontal scroll data SCD to “1”.

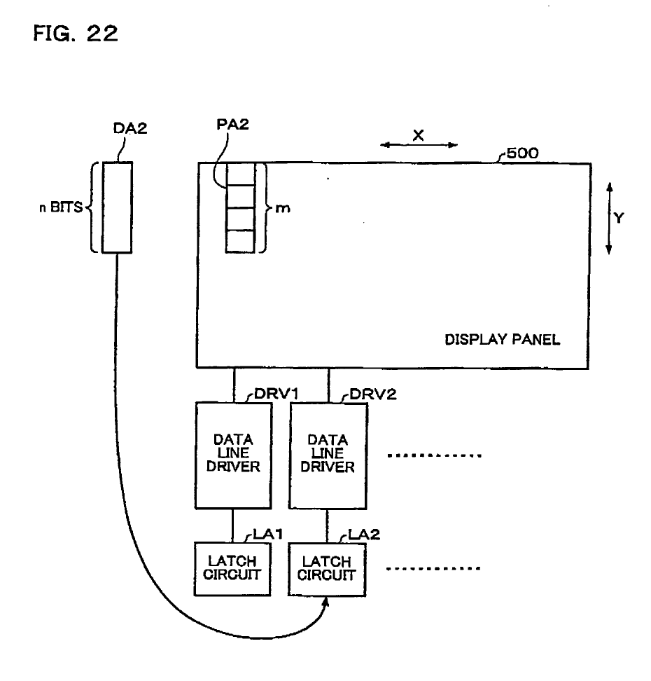

FIG. 22 is a diagram showing the m pixels PA2 displayed by the n-bit display data DA2 when the value of the horizontal scroll data SCD is “0”, for example. The n-bit display data DA2 is the display data which is output when the wordline WL2 of the display memory 200 shown in FIG. 11 is selected. In this case, the address decoder 400 obtains the latch address data LAD assigned to the latch circuit LA2 from the wordline address information when the wordline WL2 is selected. Specifically, since * the address decoder 400 outputs the latch pulse to the latch circuit LA2 when the value of the horizontal scroll data SCD is “0”, flu, n-bit display data DA2 is decoded by the decoder 100 and latched by the latch circuit LA2. This causes the data line driver section DRV2 to drive the data line, whereby the m pixels PA2 of the display panel 500 are displayed.

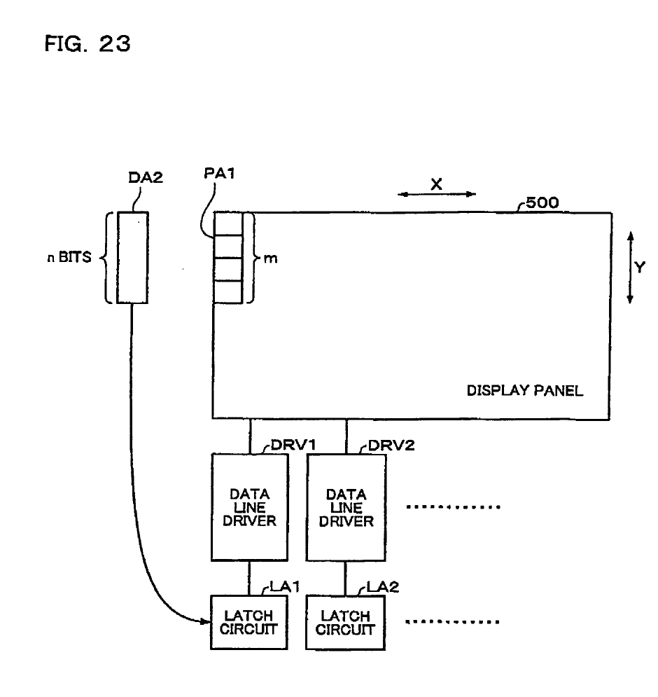

FIG. 23 is a diagram showing the case of performing the horizontal scroll display of the n-bit display data DA2 for one pixel to the left along the direction X In the case of performing the horizontal scroll display for one pixel to the left along the direction X, the horizontal scroll data SCD is set to “1”, for example. The calculation circuit 420 shown in FIG. 19 subtracts the horizontal scroll data SCD from the latch address data LAD, for example. This causes the output from the address conversion circuit 410 to be data indicating the latch circuit LA1 differing from FIG. 22. The address decoder 400 outputs the Latch pulse to the latch circuit LA1 according to the output from the address conversion circuit 410. This causes the n-bit display data DA2 to be decoded by the decoder 100 and latched by the latch circuit LA1. Specifically, the data line driver section DRV1 drives the data line, whereby the m pixels PA1 are displayed.

The above description is not limited to the horizontal scroll display for one pixel. In the case of performing the horizontal scroll display for two pixels to the right or left along the direction X, the horizontal scroll data SCD is set to “2”, for example. In the case where the number of data lines is 64, the number of data lines can be indicated by six bits. In this case, the latch address data LAD corresponding to the display data DA2 may be expressed by (000001), for example. The horizontal scroll data SCD of the horizontal scroll display for two pixels may be expressed by (000010), for example. In this case, when the calculation circuit 420 shown in FIG. 19 subtracts the horizontal scroll data SCD from the display data DA2, (000001)−(000010)=(000001)+(111110)=(111111) is obtained by using two's complement notation. In the case where the leftmost data line in the direction X is the first data line, (111111) is the address assigned to the latch circuit corresponding to the rightmost data line in the direction X. Specifically, when performing the horizontal scroll display of certain display data, the rightmost data line in the direction X is driven after driving the leftmost data line in the direction X. The leftmost data line in the direction X may be driven after driving the rightmost data line in the Lion X

Specifically, when performing the horizontal scroll display for ss (ss is an integer greater than one) pixels to the right or left along the direction X, the value of the horizontal scroll data SCD is set to ss, for example.

When performing the horizontal scroll display to the right along the direction X, the value of th horizontal scroll data SCD may be set to “−1”, and the calculation circuit 420 may perform subtraction processing. Specifically, the horizontal scroll display to the right along the direction X can be performed by setting the value of the horizontal scroll data SCD to a negative value and performing subtraction processing using the subtractor circuit 424. When performing the horizontal scroll display to the left along the direction X, the value of the horizontal stroll data SCD may be set to “−1”, and the adder circuit 422 may perform addition processing. Specifically, the horizontal scroll display to the left along the direction X can be performed by setting the value of the horizontal scroll data SCD to a negative value and performing addition processing using the adder circuit 422.

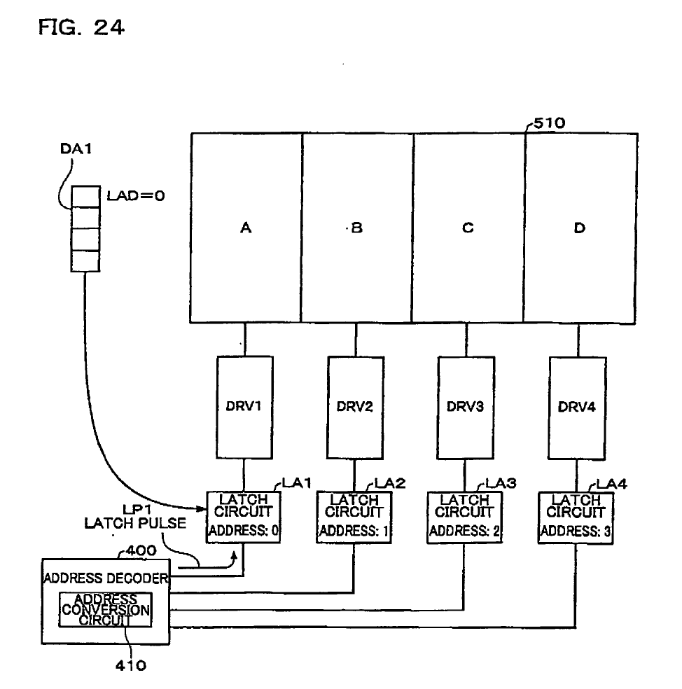

The right-left inversion display is described below. FIG. 24 is a block diagram illustrative of the right-left inversion display. FIG. 24 shows four data line driver sections DRV1 to DRV4, four latch circuits LA1 to LA4. and four display areas A to D respectively driven by the data line driver sections DRV1 to DRV4. However, the present invention is not limited thereto. In the case of performing the normal display in the display driver including the address conversion circuit 410, when the wordline WL1 is selected, the display data DA1 is decoded by the decoder 100, and the decoded data is latched by the latch circuit LA1 in the same manner as in the above-described embodiment. In this case, the value of the latch address data LAD included in the wordline address information and the value of the address assigned to the latch circuit LA1 are “0”, for example. Specifically, the address decoder 400 outputs the latch pulse LP1 to the latch circuit LA1 to which the address having the same value as the latch address data LAD is assigned. This causes the data line driver section DRV1 to drive the display area A of the display panel 510. The display areas A to D are displayed by causing the display data to be sequentially read from the display memory 200.

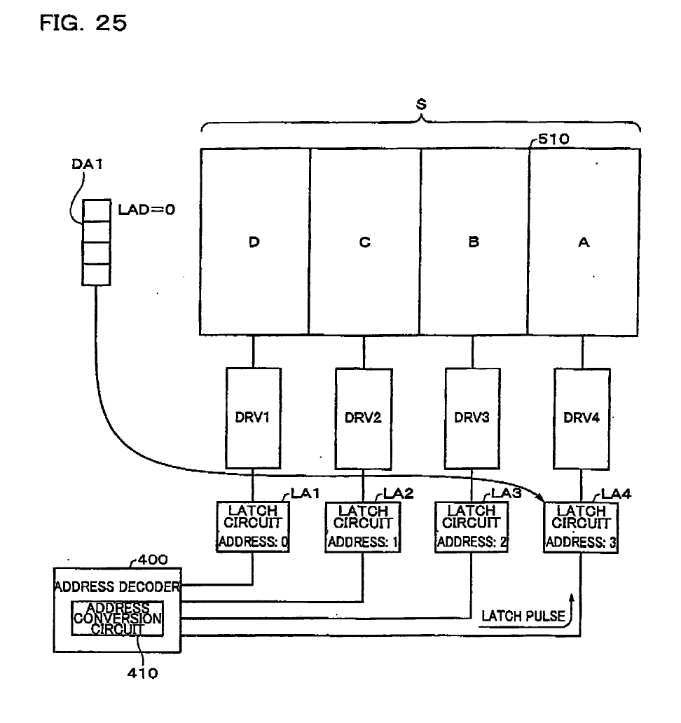

When performing the right-left inversion display, the latch pulse is output to the latch circuit determined based on the latch address data LAD when the display data DA1 is read and on the number of data lines of the display panel 510. FIG. 25 is a diagram showing the case of performing the right-left inversion display for the display panel S10 shown in FIG. 24.

In the case of performing the right-left inversion display, when the wordline WL1 is selected, the display data DA1 is decoded by the decoder 100, and the decoded data is latched by the latch circuit LA4. In this case, the value of the 1 address data LAD included in the wordline address information is “0” in the same manner as described above. However, according to FIG. 25, the address assigned to the latch circuit LA4 is “3”, and the latch pulse is output from the address decoder 400 to the latch circuit LA4. This occurs due to the function of the address conversion circuit 410. In the case of performing the right-left inversion display, the address conversion circuit 410 selects the lath circuit LA4 from among the four latch circuits LA1 to LA4 based on the latch address data LAD and the number of data lines, and outputs the latch pulse to the latch circuit LA4. When the number of data lines of the display panel 510 is S (S is an integer greater than one), the calculation circuit 420 of the address conversion circuit 410 calculates “(S−1)−LAD” when selecting the latch circuit LA4, for example. In FIG. 25, “(4−1)−=3” is obtained. The latch circuit LA4 to which the address value of “3” is assigned is selected based on the calculation result, whereby the latch pulse is input to the latch circuit LA4.

Specifically, the address of the latch circuit for performing the right-left inversion display can be obtained by subtracting “1” from the number S of data lines and subtracting the value of the latch address data LAD from the subtraction result. The right-left inversion display can be easily performed by performing the above-described processing for the display data sequentially read from the display memory 200.

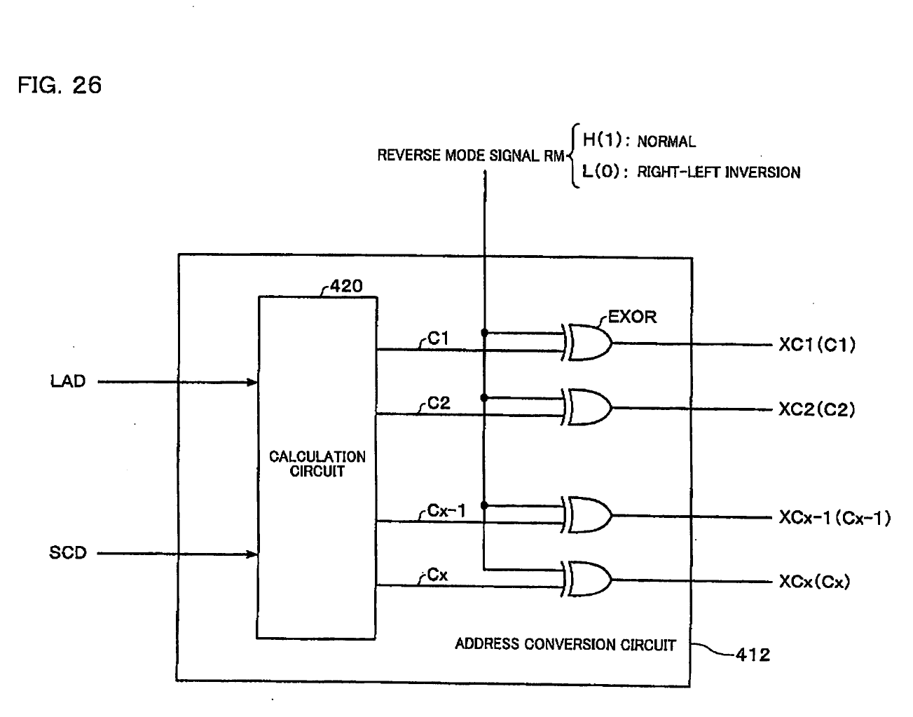

The right-let inversion display can also be easily realized by using an address conversion circuit 412 shown in FIG. 26. In the address conversion circuit 412 shown in FIG. 26, exclusive OR circuits EXOR are provided instead of the inverters provided in the address conversion circuit 410 shown in FIG. 19, for example. A reverse mode signal RM is input to one input of the exclusive OR circuits EXOR The data C1 to Cx output from the calculation circuit 420 is input to the other input of the exclusive OR circuits EXOR. In this example, the reverse mode signal RM is set to a signal at the high level (or logical value “1”) when performing the normal display, and is set to a signal at the low level (or logical value “0”) when performing the right-left inversion display.

Since the reverse mode signal RM is set at the logical value “1” when performing the normal display, the logical value “1” is input to one input of the exclusive OR circuits EXOR. The output from the exclusive OR circuit EXOR to which the logical value “0” is input at the other input is set at the logical value “1”. The output from the exclusive OR circuit EXOR to which the logical value “1” is input at the other input is set at the logical value “0”. Specifically, since each exclusive OR circuit EXOR functions as an inverter, the address conversion circuit 412 has the same function as the address conversion circuit 410 shown in FIG. 19.

Since the reverse mode signal RM is set at the logical value “0” when performing the right-left inversion display, the logical value “0” is input to one input of the exclusive OR circuits EXOR In this case, the output from each exclusive OR circuit EXOR is set at the logical value input to the other input of each exclusive OR circuit EXOR. For example, the output from the exclusive OR circuit EXOR to which the logical value “1” is input at tie other input is set at the logical value “1”. Specifically, the data C1 to Cx from the calculation circuit 420 is not reversed and output from the address conversion circuit 412.

The data output from the address conversion circuit 412 is output to the logic circuits AND of the address decoder 400 in the same manner as the address conversion circuit 410 shown in FIG. 18. However, when the reverse mode signal RM is set at the logical value “0”, the unreversed data C1 to Cx is input to the logic circuits AND shown in FIG. 18. For example, when all the data C1 to Cx is set at the logical value “0”, the output from the logic circuit AND to which the inverters NV3 are connected at all inputs is set at the logical value “1”. Specifically, the output from the logic circuit AND connected with the latch circuit LAx is set at the logical value “1”, whereby the latch circuit LAx is selected from among the latch circuits LA1 to LAx.

However, when all the data C1 to Cx is set at the logical value “0” when performing the normal display, since all the data XC1 to XCx which is the inversion data of the data C1 to Cx is set at the logical value “1”, the output from the logic circuit AND connect with the latch circuit LA1 shown in FIG. 18 is set at the logical value “1”, Specifically, when all the data C1 to Cx output from the address conversion circuit 410 is set at the logical value “1”, the latch pulse is input to the latch circuit LA1.

In other words, the latch circuit to be selected is reversed in right and left in the direction X corresponding to the reverse mode signal RM, whereby the right-left inversion display can be easily performed. Moreover, since the address conversion circuit 412 can also perform calculation for performing the horizontal scroll display using the calculation circuit 420, the horizontal scroll display can be easily performed while performing the right-left inversion display.

According to the abovedescribed embodiment and modification, the display data can be displayed on the display panel by arbitrarily selecting the latch circuits LA1 to LAx and driving the data line corresponding to the selected latch circuit without rewriting the display data in the display memory. In the case where the position of the pixel indicated by the display data is changed in real time such as in the horizontal scroll display or the right-left inversion display, it is necessary to update the display data in the display memory in the comparative example each time the position of the pixel is chanced, whereby control or the like is complicated and load is imposed on a processor or the like However, in the present embodiment and the modification, the horizontal scroll display or the right-left inversion display can be performed without rewriting the display data in the display memory.

6. Electronic Instrument

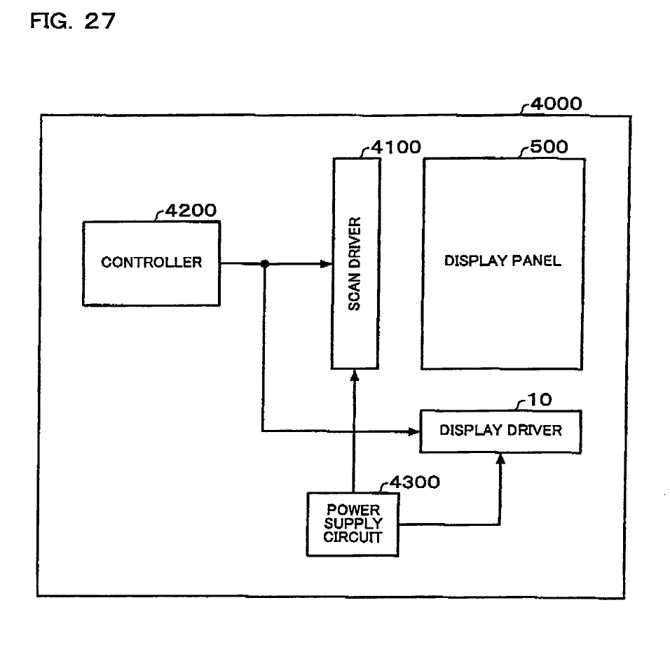

FIG. 27 is a block diagram showing a configuration of an electronic instrument including the display driver 10 according to the present embodiment. Au electronic instrument 4000 shown in FIG. 27 includes the display driver 10, the display panel 500, a scan driver 4100 which drives scan lines of the display panel 500, a controller 4200 which supplies a control signal and the like to the display driver 10 and the scan driver 4100, and a power supply circuit 4300. However, the present invention is not limited thereto. For example, the controller 4200 or the power supply may be omitted, or another device may be additionally provided

Since the display driver 10 is provided in the electronic instrument 4000, manufacturing cost of the electronic instrument 4000 can be reduced

Although only some embodiments of the present invention have been described in detail above, those skilled in the art will readily appreciate that many modifications are possible in the embodiments without departing from the novel teachings and advantages of this invention Accordingly, all such modifications are intended to be included within the scope of this invention. Any term (such as an FRC decoder, an FRCROM, an MLS decoder, a select signal for selecting a wordline, or a flip-flop) cited with a different term having broader or the same meaning (such as a grayscale decoder, a grayscale ROM, a multi-line select drive decoder, address formation on a display memory, or a latch circuit) at least once in this specification or drawings can be replaced by the different term in any place in this specification and drawings.

1. A display driver, comprising:
a decoder which decodes n-bit display data (a is an integer greater than one) sequentially input from a display memory in units of n bits;
a plurality of latch circuits which latch data decoded by tic decoder, and
a plurality of data line driver sections which drive data lines of a display panel based on the data latched by the latch circuits,
wherein the n-bit display data is read from the display memory and output to the decoder by performing wordline control once for the display memory;
wherein the decoder decodes die r-bit display data from the display memory and sequentially outputs the decoded data to the latch circuits; and
wherein each of the data line driver sections drives corresponding one of the data lines after She decoded data has been stored in the latch circuits.

2. The display driver as defined in claim 1, further comprising:
an address decoder which generates a latch pulse used by the latch circuits to latch outputs from the decoder,
wherein the address decoder selects one of the latch circuits and outputs the latch pulse to the selected latch circuit based on address information on the display memory when the n-bit display data is read.

3. The display driver as defined in claim 2,
wherein the n-bit display data is read from the display memory in synchronization with one of a rising edge and a falling edge of a clock signal from a control circuit; and
wherein the address decoder outputs the latch pulse in synchronization with the other of the rising edge and the falling edge of the clock signal.

4. The display driver as defined in claim 1,
wherein the latch circuits connected in series form a shift register, an output terminal of one of the latch circuits being connected to an input terminal of one of the latch circuits in a subsequent stage; and
wherein the shift register shifts data sequentially input from the decoder to one of the latch circuits in a first stage and stores the shifted display data.

5. The display driver as defined in claim 1,
wherein the decoder includes a multi-line select drive decoder; and
wherein the multi-line select drive decoder generates drive voltage select data based on display data for m pixels (m is an integer greater than one) extracted from the n-bit display data, and outputs the drive voltage select data to the latch circuits, the drive voltage select data being used for selecting one of drive voltages for multi-line select drive of scan lines.

6. The display driver as defined in claim 2,
wherein the decoder includes a multi-line select drive decoder, and
wherein the multi-line select drive decoder generates drive voltage select data based on display data for m pixels (m is an integer greater than one) extracted from the n-bit display data, and outputs the drive voltage select data to the latch circuits, the drive voltage select data being used for selecting one of drive voltages for multi-line select drive of scan lines.

7. The display driver as defined in claim 4,
wherein the decoder includes a multi-line select drive decoder, and
wherein the multi-line select drive decoder generates drive voltage select data based on display data for m pixels (m is an integer greater than one) acted from the n-bit display data, and outputs the drive voltage select data to the latch circuits, the drive voltage select data being used for selecting one of drive voltages for multi-line select drive of scan lines.

8. The display driver as defined in claim 5,
wherein each of the data line driver sections selects a data line drive voltage from among the drive voltages, based on the drive voltage select data stored in the latch circuits; and
wherein the data line driver sections uses the data line drive voltage to drive the data lines.

9. The display driver as defined in claim 1,
wherein the decoder includes a grayscale decoder; and
wherein the grayscale decoder determines a display pattern of pixels indicated by the n-bit display data, based on the n-bit display data and frame information.

10. The display driver as defined in claim 2,
wherein the decoder includes a grayscale decoder; and
wherein the grayscale decoder determines a display pattern of pixels indicated by the n-bit display data, based on the n-bit display data and frame information.

11. The display driver as defined in claim 4,
wherein the decoder includes a grayscale decoder; and
wherein the grayscale decoder determines a display pattern of pixels indicated by the n-bit display data, based on the n-bit display data and frame information.

12. The display driver as defined in claim 9,
wherein the grayscale decoder outputs data “0” or “1” to at least one of the latch circuits based on the display pattern.

13. The display driver as defined in claim 9,
wherein the decoder further includes a multi-line select drive decoder used for a multi-line select drive method in which m scan lines (m is an integer greater than one) are simultaneously selected and driven; and
wherein the multi-line select drive decoder outputs drive voltage select data to the latch circuits based on the display pattern the drive voltage select data being used for selecting a data line drive voltage for driving the data line.

14. The display driver as defined in claim 13,
wherein each of the data line driver sections selects the data line drive voltage from among a plurality of types of drive voltages used for multi-line select drive of the scan lines, based on the drive voltage select data stored in the latch circuits; and
wherein the data line driver sections uses the data line drive voltage to drive the data lines.

15. The display driver as defined in claim 14,
wherein a grayscale of each pixel in display data for m pixels extracted from the n-bit display data is indicated by k-bit grayscale data (k is an integer greater an one);
wherein the grayscale decoder includes a grayscale ROM for determining a grayscale pattern which indicates two types of display states, based on the k-bit grayscale data and the frame information;
wherein the grayscale decoder determines the grayscale pattern for each of the m pixels based on the grayscale ROM, and outputs m-bit display data to the multi-line select drive decoder, the m-bit display data indicating a display state of each of the m pixels by using “0” or “1” based on the determined grayscale pattern and
wherein the multi-line select drive decoder generates the drive voltage select data based on the m-bit display data and outputs the drive voltage select data to the latch circuits.

16. An electronic instrument, comprising:
the display driver as defined in claim 1;
a display panel;
a scan driver which drives scan lines of the display panel;
a controller which controls the display driver and the scan driver; and
a power supply circuit

17. An electronic instrument, comprising:
the display driver as defined in claim 2;
a display panel;
a scan driver which drives scan lines of the display panel;
a controller which controls the display driver and the scan driver; and
a power supply circuit

18. An electronic instrument, comprising:
the display driver as defined in claim 4;
a display panel;
a scan driver which drives scan lines of the display panel;
a controller which controls the display driver and the scan driver; and
a power supply circuit

19. Au electronic instrument, comprising:
the display driver as defined in claim 5;
a display panel;
a scan driver which drives scan lines of the display panel;
a controller which controls the display driver and the scan driver, and
a power supply circuit.

20. An electronic instrument, comprising:
the display driver as defined in claim 9;
a display panel;
a scan driver which drives scan lies of the display pane;
a controller which controls the display driver and the scan driver; and
a power supply circuit.
